(19) United States
(12) Patent Application Publication
(10) Pub. No.: US 2010/0238489 A1
(43) Pub. Date: Sep. 23, 2010

(54) DISTRIBUTED PROCESSING PRINTER

(75) Inventors: Eric Meyerhofer, Pasadena, CA (US); John Hilbert, Torrance, CA (US)

Correspondence Address: FITZPATRICK CELLA HARPER & SCINTO, 1290 Avenue of the Americas, NEW YORK, NY, 10104-3800, US

(73) Assignee: FUTURELOGIC, INC., Glendale, CA (US)

(21) Appl. No.: 12/664,860

(22) PCT Filed: Jun. 16, 2008
(86) PCT No.: PCT/US08/67153

§ 371 Date: Jun. 4, 2010

Related U.S. Application Data
(60) Provisional application No. 60/944,401, filed on Jun. 15, 2007.

(51) Int. Cl. G06F 15/00

(52) U.S. Cl. 358/1.15

(57) ABSTRACT

A distributed processing printer which may include separate controllers and/or separate memory where one controller and/or memory may be used to support legacy applications and another controller and/or memory may be used to support printing promotional materials and/or messages in a manner completely transparent to the legacy applications. The printer is capable of magnetically, electronically, and/or thermally reading, writing, erasing, and/or encoding gaming vouchers, promotional coupons, and rewritable cards. The printer can be integrated into a cashless slot machine and other games and/or a promotional system in a casino that produces gaming vouchers, promotional coupons and messages and/or print on demand player tracking card/vouchers capable of communicating with a game or host. The printer may accept various kinds of media, such as thermally writable media, smart cards, or magnetic strip cards. The printer may include writing, reading, erasing and/or encoding devices within the printer to manage and use the different types of media. In addition, the printer may include control logic and articulated printing mechanisms that prevent the printer from inadvertently manipulating a gaming voucher in an inappropriate manner.

### CROSS-REFERENCE TO RELATED APPLICATIONS

The present application claims the benefit of U.S. Provisional Application No. 60/944,401 filed Jun. 15, 2007, the contents of which are incorporated by reference as if stated in full herein.

### FIELD OF THE INVENTION

This invention relates to gaming and gaming printers, and more specifically to a distributed processing printer which includes separate controllers and/or separate memory where one controller and/or memory is used to support legacy applications and another controller and/or memory are used to support printing promotional materials and/or messages in a manner completely transparent to the legacy applications.

### BACKGROUND OF THE INVENTION

Over the last several years, cashless enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. Practical field experience with the application has illustrated that there are areas for improvement in current printer designs and implementation within the game.

One area for improvement relates to the printing of both vouchers and promotional coupons. Currently, paper is pulled from one paper tray for both vouchers and coupons. Additionally, the voucher must be printed first, followed by one or more coupons. This invention offers an improvement to existing printers by using multiple paper trays and a media escrow area thereby allowing the printer to print coupons after receiving a cash-in signal from a host system either at the beginning, middle, or end of a player session and storing the coupons in the media escrow area until the printer receives a cash-out signal from a host system.

Another area for improvement relates to the printer connectivity to multiple hosts. By adding one or more additional controllers, legacy applications can be supported by a first controller and in such a manner complete transparent to the legacy applications, additional controllers can be used to print promotional materials and messages using the same printer.

### DEFINITIONS

For the purposes of this document the following definitions apply:

“Gaining Machine”, “Game Machine” or “Game” —A slot machine, gaming machine, or game table in a Gaming Establishment.

“Gaming Establishment” —A gaming entity such as a casino.

“Business Establishment” —A business entity which may use a kiosk for consumer purchases such as movie tickets, parking tickets, venue tickets, etc., or a retail business entity.

“Gaming Voucher” —A media, such as paper, containing sufficient information to identify at a minimum, an amount of money and a validation number use to authenticate the transaction.

“Promotional Coupon” —A media, such as paper, containing sufficient information to identify at a minimum, a promotional offer made to a patron.

“Host” or “Host System” —A server or multiple servers, a computer connected to a network, a stand alone computer, a handheld device, or a wireless device used for application and data storage, data processing, and file transfers that sends and/or receives information to and/or from the printer encoder. One example of a host system is a Gaming System used in Gaming Establishments which controls a plurality of games, such as cashless enabled slot machines, to perform game voucher printing. Another example is a Promotional System which controls and performs the printing of promotional coupons, vouchers and other printed items of interest to a Gaming Establishment or its patrons. Another example is a Venue Ticketing System which controls and issues tickets for venues at or for a Business Establishment.

“Bluetooth” —Short range wireless technology for connecting different devices such as a printer and a personal digital assistant (PDA).

“WiFi” —A network that uses high frequency radio signals for data transmission over distances of a few hundred feet.

“Grayscale Images or Graphics” —images or graphics with multiple pixels where the value of each pixel is composed of shades of gray or another color.

“One Color Images or Graphics” —Images with a single pixel of either black or white.

“Thermal Printers” —A printer where paper with a heat sensitive side is imaged using a print head which applies heat in tiny dots ( 1/200th of an inch in size or smaller) in order to turn the area black. In this manner, all images are created by a series of tiny black dots. A widely known example of a thermal printer is the original fax machines.

“Thermal Media” —A type paper with a heat sensitive side is imaged using a print head which applies heat in tiny dots ( 1/200th of an inch in size or smaller) in order to turn the area black or another color.

“Bill Acceptor” —A device which automatically accepts paper currency by scanning it and saving the paper currency within the machine. A coin change machine always has such a device on it, and more recently, so do all slot machines.

“Ticket Image” —The image(s) created on the paper by a common process of imaging dots on the paper.

“Rewritable Card” —Media such as a smart card, magnetic media, thermal media, thermal reversible media, RF fiber media, RFID tag media, and/or write once media which may be used as a Game Voucher or Promotional Voucher, among others.

“Smart Card” —A device that normally takes the form of a credit voucher size and contains electronic circuitry and an interface commonly known as a swipe interface as a mechanism of electrically connecting to a reading device.

“Magnetic Media” —A device containing a magnetic stripe that is programmable and readable by sliding and/or placing the magnetic Stripe adjacent to an interface device, such as the magnetic stripe used on credit vouchers.

“Thermal Media” —A type of media such as paper or rewritable card, with a heat sensitive side is imaged using a print head which applies heat in tiny dots ( 1/200th of an inch in size or smaller) in order to turn the area black.

“Thermal Reversible Media” —A type of media such as paper or rewritable card containing a multi-stable thermal layer. This layer is stable in clear or opaque (black or other colors), depending on the amount of heat applied by the thermal print head.

“RF Fiber Media” —A type of media such as paper or rewritable card containing Radio Frequency active elements that are grouped together in such a manner so as to provide information about the paper or voucher stock.

“RF ID Tag Media” —A type of media such as paper or rewritable card containing a Radio Frequency circuit that can hold information and does not require a direct electrical connection as an interface connection.

“Write Once Media” —A definition referring to any media that can only be written on or imaged one time. Standard thermally active paper is an example.

### SUMMARY OF THE INVENTION

The present invention identifies a distributed processing printer which uses separate controllers and/or separate memory where one controller and/or memory are used to support legacy applications and another controller and/or memory are used to support printing promotional materials and/or messages in a manner completely transparent to the legacy applications. The printer is capable of magnetically, electronically, and/or thermally reading, writing, erasing, and/or encoding gaming vouchers, promotional coupons, and rewritable cards, interfacing with a wide range of media types. The printer can be integrated into a cashless slot machine and other games and/or a promotional system in a casino that produces gaming vouchers, promotional coupons and messages, and/or print on demand player tracking card/vouchers capable of communicating with a game or host.

In one aspect of the invention, the distributed processing printer may include a print module, a plurality of controllers, a plurality of processors, a plurality of ports or interfaces, a plurality of firmware, a gating mechanism, a plurality of physically separated memory, a media supply, procedures, code, and certain shared hardware resources, among others.

In another aspect of the invention, the print module produces human and/or machine readable indicia on media.

In another aspect of the invention, the print module is coupled to one or a plurality of controllers where one controller may support legacy applications and another controller may support printing promotional materials and/or messages.

In another aspect of the invention, the one or a plurality of process communications, image generation, and print data storage; each controller sending and receiving signaling from a separate and coupled host.

In another aspect of the invention, each controller of the one or a plurality of controllers may include or be coupled to a processor, memory coupled to the processor, a communications port or interface coupled to the processor, print data storage, and executable firmware, where each controller and processor may operate independently from the other.

In another aspect of the invention, the one or a plurality of controllers are internal to the distributed processing printer.

In another aspect of the invention, the one or a plurality of controllers are external to the distributed processing printer; the printer and each external controller transmit signaling over a physical distance using RF or IR communications.

In another aspect of the invention, a controller coupled to a plurality of controllers monitors the communication of the one or plurality of controllers and thereby determine which controller is connected to operate the shared resources of the printer.

In another aspect of the invention, a first controller permits the first controller to signal the other controllers as to which controller has been granted ownership of the shared resources of the distributed processing printer.

In another aspect of the invention, a distributed processing printer may include a plurality of controllers where one controller is coupled to an electronic gaming machine and running legacy firmware for the purposes of printing gaming vouchers and another controller is coupled to a promotional host for the purposes of printing coupons and other promotional materials in a manner that is completely transparent to the legacy firmware running on the controller coupled to an electronic gaming machine.

In another aspect of the invention, a distributed processing printer may include a plurality of controllers, where each controller may determine whether itself or another controller was connected to the shared print module or other shared resources of the printer at any given time.

In another aspect of the invention, a distributed processing printer may include a plurality of controllers, where one controller may determine the progress of print activity of another controller.

In another aspect of the invention, a distributed processing printer may include a plurality of controllers, where one controller may monitor the communications between another controller and its coupled host.

In another aspect of the invention, a controller monitors the activity of the print module.

In another aspect of the invention, one or a plurality of processors send and receive signaling to and from one or a plurality of controllers.

In another aspect of the invention, one or a plurality of processors monitor communications of a plurality of controllers.

In another aspect of the invention, a distributed processing printer may include a plurality of processors where one processor serves as a slave to remotely locate a controller, such that the controller transmit messages to the processor ordering it to perform the processes necessary to operate the shared resources of the printer.

In another aspect of the invention, a distributed processing printer may include a processor and a plurality of memory where the processor performs task switching between the execution of code from a first memory and a second memory, where the processor performs the task switching in response to host communications from one or a plurality of hosts such that the code executed and the print data accessed in each memory provides a unique environment from the perspective of each of the connected hosts, and the processor performs the switching so as to produce pseudo-simultaneous operation of the executable code in each memory in a manner transparent to the host on at least one port or interface.

in another aspect of the invention, a distributed processing printer may include one or a plurality of ports or interfaces, each port or interface is coupled to a separate host.

In another aspect of the invention, a distributed processing printer may include a plurality of ports or interfaces where one port or interface is used for processing of real time play activity data.

In another aspect of the invention, a printer may include a plurality of ports or interfaces, a plurality of controllers, and a shared print module, each port or interface coupled to a separate host, where the data received from one host is received on one controller to determine if and when that controller will signal the shared print module resource to produce human and/or machine readable indicia on the media of the distributed processing printer.

In another aspect of the invention, a printer may include a plurality of ports or interfaces and a plurality of controllers where one port is coupled to an electronic gaming machine which outputs real time play activity data of the game, one controller receives the data and looks for play activity which may trigger printing of a promotional coupon or message, when the controller sees such a trigger match, the controller prints the particular promotional coupon or message and the controller signals its coupled host on another port or interface as to the creation of the promotional coupon or message.

In another aspect of the invention, a gating mechanism determines which controller is addressing the print module of the distributed processing printer.

in another aspect of the invention, a gating mechanism controls the printer engine that is shared by a plurality of controllers.

In another aspect of the invention, a gating mechanism is coupled to one or a plurality of controllers.

In another aspect of the invention, a gating mechanism is internal or external to the distributed processing printer.

In another aspect of the invention, the devices for driving a gating mechanism are firmware, software, electrical, and/or mechanical.

In another aspect of the invention, one or a plurality of memory may provide firmware code and data storage/processing unique to each separate and coupled host.

In another aspect of the invention, a plurality of memory are separated or segmented from other memory where one portion of memory may exist in the distributed processing printer and another portion of memory may exist in one or a plurality of controllers.

In another aspect of the invention, a printer may include a plurality of memory, where each memory may contain different executable code and print data storage, such as a portion of the memory, is utilized for gaming machine content, promotional coupon content, and/or host system content, among others.

In another aspect of the invention, a portion of the memory is utilized for mapping to a main communication interface, secondary communication interface, and/or auxiliary communication interface, among others.

In another aspect of the invention, a plurality of firmware, each separate from the other, where one firmware supports legacy applications or systems such as an electronic gaming machine, and another firmware supports printing promotional coupons and messages.

In another aspect of the invention, a printer may include procedures, code, a plurality of controllers, a plurality of ports or interfaces, a gating mechanism, among others, where the procedures and code monitors communications traffic on one port or interface coupled to one controller and determine if the controller has been signaled by its coupled host to create printed output, and when so determined, gating the print module and any other switch-able shared resources of that controller.

In another aspect of the invention, a printer may include procedures, code, a plurality of controllers, and a gating mechanism, among others, where the procedures and code provides for a second controller to receive signaling from its coupled host, queue up printed output, monitor communications between a first controller and its coupled host, monitor print activity of the first controller, determine when the first controller has finished with the shared resources, and when so determined, gate control of the shared resources to itself and print its queued up output.

In another aspect of the invention, a printer may include procedures, code, a plurality of controllers, and a gating mechanism, where the procedures and code define a second controller to receive signaling from its coupled host, monitor signaling between a first controller and its coupled host, determine if print activity is required by the first controller and if none is required, take ownership of the shared resources and cause the print module to create printed output, further cause the print module to deposit the printed output into a physical escrow area, all while continuing to monitor communications between the first controller and its coupled host, determining when its print activity must cease in order to grant ownership of the shared resources to the first controller, then gating the print module and shared resources to the first controller all in a manner transparent to the first controller so that the first controller may produce printed output.

In another aspect of the invention, a distributed processing printer may include a media escrow area to store printed output, such as promotional coupons or messages until such time that a cash-out signal is received, thereby causing the printer to generate a gaming voucher and producing such voucher to the patron along with each promotional coupon or message stored in the escrow area.

In another aspect of the invention, a distributed processing printer may include one or a plurality of media escrow areas where one or all areas are accessed externally to the printer.

In another aspect of the invention, a distributed processing printer provides for mid-session or begin session coupon printing after a game coupled to such printer receives a cash-in signal.

In another aspect of the invention, a distributed processing printer prints one or a plurality of media and hold such media in escrow in a media escrow area pending other media to be printed.

In another aspect of the invention, the distributed processing printer may accept various kinds of media, such as thermally writable media, smart cards, or magnetic strip cards. The printer may include writing, reading, erasing and/or encoding devices within the printer to manage and use the different types of media. In addition, the printer may include control logic and articulated printing mechanisms that prevent the printer from inadvertently manipulating a gaming voucher in an inappropriate manner.

In another aspect of the invention, the distributed processing printer may print and scan thermal images, not limited to barcodes, created on thermally reactive media.

In another aspect of the invention, the distributed processing printer may interface with a “smart card” used in games and/or promotional systems for the convenience of player identification, statistical information, playing credits and banking information.

In another aspect of the invention, the distributed processing printer may interface with thermal reversible media used in games and/or promotional systems to convey credit amounts and other information of interest to a player of the gaming machines.

In another aspect of the invention, the distributed processing printer may interface with RF Fiber Media, where the RF Fiber Media consists of radio frequency resonators, or fibers, that are randomly or pseudo-randomly placed on a carrying medium, the medium can be standard thermal paper or other suitable carrying medium, the collection of the resonators placed on the medium in the random manner form a relatively unique signature, the signature can be obtained by applying an electro magnetic signal, the signal typically in the radio frequency spectrum, as the signal is applied, each of the resonators produce an electro magnetic response to the signal, the response is received and the collection of all the responses form the signature, and the signature either alone or in combination with other authentication mechanisms of gaming voucher and/or promotional coupon provide an increased certainty of the authentication.

In another aspect of the invention, the distributed processing printer may interface with RF ID Tag Media, where the RF ID Tag Media comprising the mechanisms to allow information to be written and read electronically, and the information is used either alone or in combination with other authentication mechanisms of the gaming voucher and/or promotional coupon providing an increased certainty of the authentication.

In another aspect of the invention, the distributed processing printer may print on write once media, scan the media to determine its content, and write on the media repeatedly until the predefined writing zones are full, as well as the mechanism to store the media for later retrieval.

In another aspect of the invention, the distributed processing printer may include a detection mechanism to identify the type of media that is inserted into the printer. The detection mechanism may include a smart card detection circuit, using a reader for magnetic media, using a radio frequency circuit for RF ID tag media, using a radio frequency circuit for RF fiber media, using optical scanning and/or thickness measurement for thermal reversible media, and using optical scanning and/or thickness measurement for write once media, among others.

In another aspect of the invention, a distributed processing printer provides for grayscale printing whereby the printer may print multiple shades of a foreground color on a background color.

These and other features, aspects, and advantages of the present invention will become better understood with regard to the following description and accompanying drawings.

### BRIEF DESCRIPTION OF THE DRAWINGS

FIG. 1a is a block diagram of a distributed processing printer in accordance with an exemplary embodiment of the present invention.

FIG. 1b is a block diagram of a distributed processing printer having two print controllers in accordance with an exemplary embodiment of the present invention.

FIG. 2a is an illustration of a distributed processing printer with a media escrow area in accordance with an exemplary embodiment of the present invention.

FIG. 2b is an illustration of a distributed processing printer with a plurality of paper trays and a media escrow area in accordance with an exemplary embodiment of the present invention.

FIG. 2c is an illustration of a distributed processing printer with a plurality of paper trays utilizing one paper path in accordance with an exemplary embodiment of the present invention.

FIG. 3 is an illustration of the segmented memory and memory map of a distributed processing printer in accordance with an exemplary embodiment of the present invention.

FIG. 4 is a block diagram of the media escrow process for one or a plurality of promotional coupons in accordance with an exemplary embodiment of the present invention.

FIG. 5 is an illustration of print arbitration process of a distributed processing printer in accordance with an exemplary embodiment of the present invention.

FIG. 6 is a diagram of a security test performed on the memory of a distributed processing printer in accordance with an exemplary embodiment of the present invention.

FIG. 7 is a diagram of a distributed processing printer comprising a plurality of controllers in accordance with an exemplary embodiment of the present invention.

FIG. 8 is a diagram of a distributed processing printer with a processor monitoring communications of a plurality of controllers in accordance with an exemplary embodiment of the present invention.

FIG. 9 is a diagram of a distributed processing printer with a processor serving as a slave to a secondary controller in accordance with an exemplary embodiment of the present invention.

FIG. 10 is a diagram of a distributed processing printer comprising one controller in accordance with an exemplary embodiment of the present invention.

FIG. 11a is a prior art illustration of a gaming voucher used currently used in a gaining environment in accordance with an exemplary embodiment of the present invention.

FIG. 11b is an illustration of a grayscale gaming voucher for use in a gaming environment in accordance with an exemplary embodiment of the present invention.

FIG. 12a is a prior art illustration of a promotional coupon in accordance with an exemplary embodiment of the present invention.

FIG. 12b is an illustration of a grayscale promotional coupon in accordance with an exemplary embodiment of the present invention.

FIG. 13a is an illustration of a rewritable card in accordance with an exemplary embodiment of the present invention.

FIG. 13b is an illustration of another portion of a rewritable card having a static memory in accordance with an exemplary embodiment of the present invention.

### DETAILED DESCRIPTION

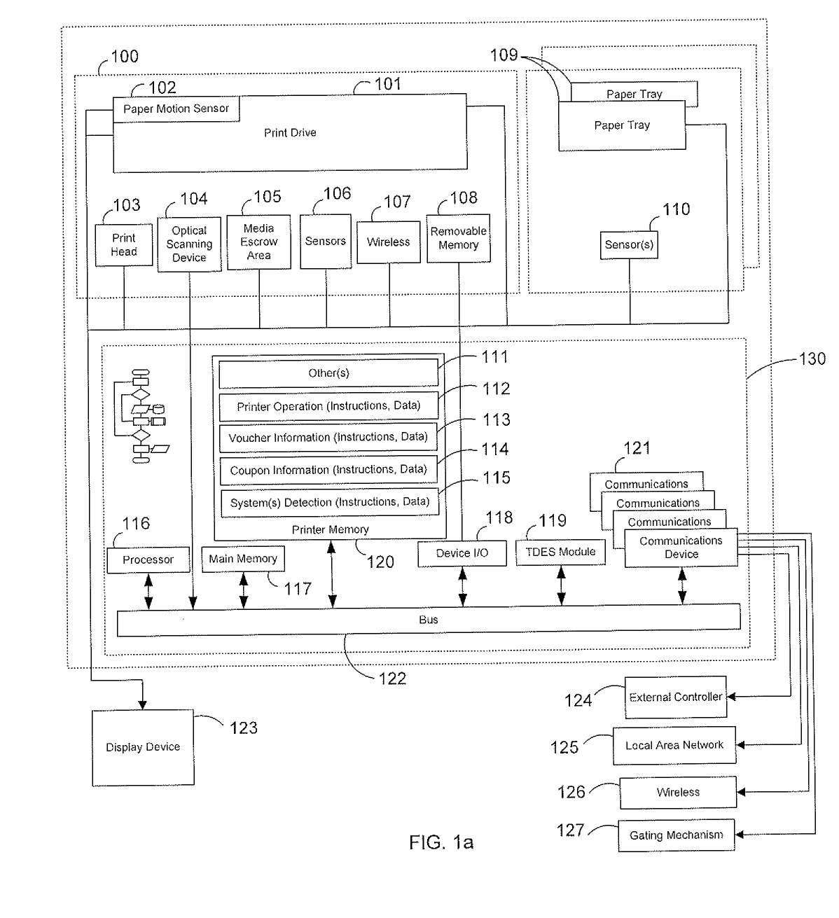

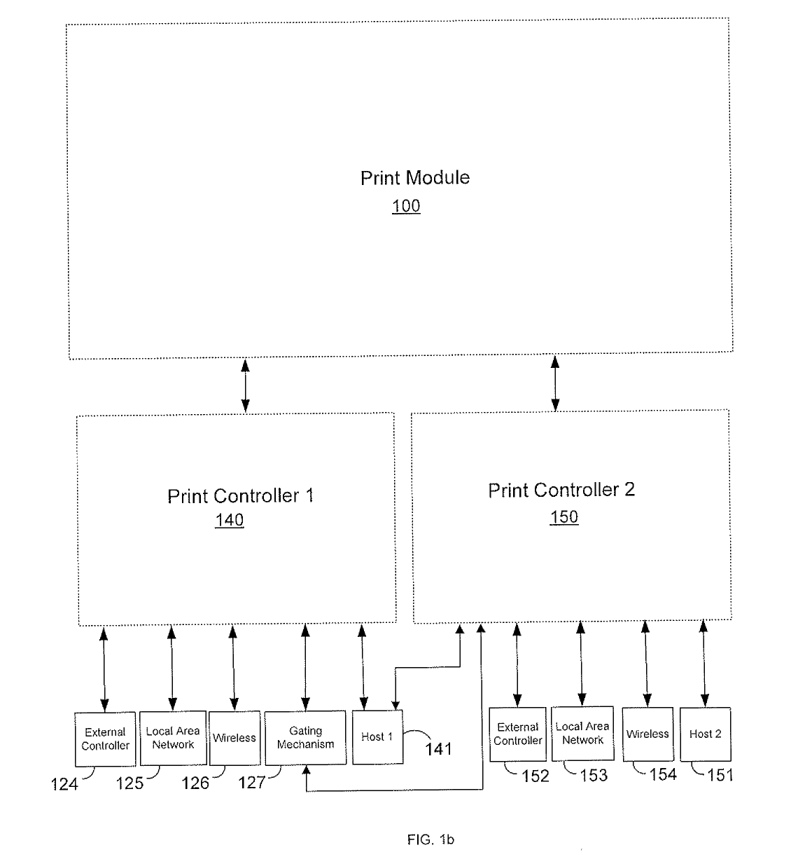

FIG. 1a is a block diagram of a distributed processing printer in accordance with an exemplary embodiment of the present invention. A component or plurality of components shown in FIG. 1a may be optional.

The distributed processing printer may include separate controllers and/or separate memory where one controller and/or memory is used to support legacy applications and another controller and/or memory is used to support printing promotional materials and/or messages in a manner completely transparent to the legacy applications. The printer is capable of magnetically, electronically, and/or thermally reading, writing, erasing, and/or encoding gaming vouchers, promotional coupons, and rewritable cards. The printer can be integrated into a cashless slot machine and other games and/or a promotional system in a casino that produces gaming vouchers, promotional coupons and messages and/or print on demand player tracking card/vouchers capable of communicating with a game or host. The printer may accept various kinds of media, such as thermally writable media, smart cards, or magnetic strip cards. The printer may include writing, reading, erasing and/or encoding devices within the printer to manage and use the different types of media. In addition, the printer may include control logic and articulated printing mechanisms that prevent the printer from inadvertently manipulating a gaming voucher in an inappropriate manner.

The print module 100 may include a print drive 101 that moves media such as a gaming voucher or promotional coupon through the print module 100. The print drive 101 is reversible such that media may be fed through the print module 100 in more than one direction by the print drive 101. The print drive 101 may include a paper motion sensor 102 for sensing media movement within the print drive 101. A more detailed discussion of printer media motion detection within a printer is presented in U.S. patent application entitled “PAPER MOTION DETECTOR IN A GAMING MACHINE”, attorney docket number 50820/FLC/F392 filed Aug. 12, 2003, the contents of which are hereby incorporated by reference as if stated herein in full.

The print module 100 further may include a print head 103 for writing indicia to media such as a gaming voucher or promotional coupon. The print module 100 provides for grayscale printing whereby the printer may print multiple shades of a foreground color on a background color. The print module 100 produces human and/or machine readable indicia on media.

The print module 100 further may include an optical scanning device 104 for scanning the indicia printed onto media. A printer controller 130, hosted by the data processing system, may use the optical scanning device 104 as an interface to receive voucher scan signals from an optical scanning device. The optical scanning device 104 is used to scan thermal images created on thermally reactive media by the printer. The thermal images may include, but not be limited to, barcodes. The printer may print on write once media, scan the media to determine its content, and write on the media repeatedly until the predefined writing zones are full, as well as store the media for later retrieval.

The print module 100 further may include a media escrow area 105. The media escrow area 105 may serve as a mechanism where after one or a plurality of media is printed, such media is held in escrow while waiting for other media to be printed. The printing and storing of media in a media escrow area 105 may occur simultaneously with other functions or processes of the printer such as interfacing and communicating with other devices. The media escrow area 105 is accessed externally to the printer. For example, in one embodiment, a distributed processing printer may process data related to one or a plurality of promotional coupons and print such coupons at the beginning of a player session such as after the game coupled to the printer transmits to the printer that a cash-in signal was received. Each promotional coupon is stored in the media escrow area 105 until the game transmits to the printer that a cash-out signal was received, after which the printer may print a gaming voucher and present to a player the gaming voucher and the one or plurality of promotional coupons from the media escrow area 105.

In another embodiment, the printer may process and print one or a plurality of promotional coupons anytime during a player session and store each coupon in the media escrow area 105. Again, after the coupled game transmits to the printer that a cash-out signal was received, the printer may print a gaming voucher and present to a player the gaming voucher and each coupon stored in the media escrow area 105.

In a preferred embodiment, the printing and storing of media in a media escrow area may occur simultaneously with other functions or processes of the printer such as interfacing and communicating with other devices.

The print module 100 further may include an interface to one or a plurality of sensors 106 coupled to the processor via the system bus 122. A gaming machine printer controller 130, hosted by the data processing system, may use the sensor interface 106 to receive sensor signals from various components of a printer as previously described. The sensor interface 106 may include a detection mechanism to identify the type of media that is inserted into the printer. The detection mechanism may include a smart card detection circuit (not shown), using a reader for magnetic media, using a radio frequency circuit for RF ID tag media, using a radio frequency circuit for RF fiber media, using optical scanning and/or thickness measurement for thermal reversible media, and using optical scanning and/or thickness measurement for write once media, among others.

The print module 100 further may include one or a plurality of interfaces to wireless technology 107. A wireless device interface 107 may serve as the mechanism to interface and communicate with other devices using wireless technology where such interfacing may occur simultaneously with other functions or processes of the printer such as printing. Wireless device technology may include Bluetooth, WiFi, wireless USB, among others. A wireless device may include any wireless device such as PDAs, personal computers, local or wide area networks, handheld devices, routers, gaming machines such as a slot machine, vending machines or kiosks, among others.

The print module 100 further may include one or a plurality of interfaces to removable memory devices 108. A removable memory device interface 108 is used as a mechanism to interface with one or a plurality of removable memory devices (not shown) such as a memory stick or FLASH stick, among others. Each removable memory device is internal or external to the printer. The interface to such devices may include a USB interface. In one embodiment, the printer may include one or a plurality of removable memory device interfaces 108.

In another embodiment, the contents of a removable memory device may include promotional coupon data such as graphics and templates, trigger metrics, promotional campaigns as well as language and font packs, and firmware to upload, among others.

The print module 100 may be removably and electronically coupled to the printer controller 130 and removably and mechanically coupled to one or a plurality of paper trays 109.

In operation, the print module 100 receives printer control signals from the printer controller 130. In response to the printer control signals, the print module 100 thermally prints on the media, under the control of the printer controller 130.

The one or more paper trays 109 store media and provide the media to the print module 100 on command from the printer controller 130. In operation, the paper tray 109 receives media control signals from the printer controller 130. In response to the control signals, the paper tray 109 feeds media to the printer. The paper tray 109 also may include one or more sensors 110 which may be used to detect the media stored in a paper tray. A plurality of paper trays may be used to hold media for use with promotional coupons and gaming vouchers. One tray may be used for the promotional coupon media and another tray for gaming voucher media.

The printer may include one or a plurality of controllers which may include a processor 116 coupled to a main memory 117 by a system bus 122. The printer controller 130 also may include a printer memory 120 coupled to the processor 116 by the system bus 122, the printer memory 120 may include the firmware for system detection 115, printer operation 112, voucher information 113, coupon information 114, and others 111. Each printer controller may be internal or external to the distributed processing printer. In one embodiment, a controller coupled to a plurality of controllers, where the controller may monitor the communication of the one or plurality of controllers and thereby determine which controller is connected to operate the shared resources, such as the print module 100 and/or gating mechanism 127, among others. Each controller may be used to monitor the activity of the print module 100, among others.

In another embodiment, the print module 100 may be coupled to one or a plurality of controllers where one controller may support legacy applications and another controller may support printing promotional materials and/or messages.

The printer memory 120, either internal and/or external, may consist of such common devices (not shown) as RAM, EPROM, EEPROM, FLASH Chips, magnetic storage devices such as floppy or hard drivers, Flash Sticks and other storage media commonly used in the computer industry. The printer memory 120 may include a plurality of memory sections that may be independently addressed for both content read and content write operations. A printer operation 112 section may be included for storage of programming instruction codes and printer data used by the processor to operate the printer as well as firmware code and/or data storage/processing unique to each separate and coupled host. The execution of these codes may determine the conditions under which voucher information 113, including voucher generation instructions and voucher data included in a voucher information section are utilized to generate a gaming voucher. A coupon information section 114 may be included in the printer memory 120 to hold coupon generation instructions and coupon data used by the printer to generate a promotional coupon.

In one embodiment, the printer may include a plurality of firmware (not shown), each separate from the other, where one firmware supports legacy applications or systems such as an electronic gaming machine, and another firmware supports printing promotional coupons and messages.

The system detection section 115 of the printer memory 120 may be used by the printer to configure itself after power up to perform gaming voucher printing, promotional coupon printing, or a combination thereof based on the system or plurality of systems detected. The system detection section 115 also may detect whether the printer is operating in a cashless enabled game within a gaming system, a promotional system, or a combination thereof without recycling the power to the printer. Upon detection of a gaming system, the system detection section 115 of the printer memory 120 then may interact with the printer operation section 112 and voucher information section 113 of the printer memory 120 to allow the printer to generate gaming vouchers. Upon detection of a promotional system, the system detection section 115 of the printer memory 120 then may interact with the printer operation section 112 and coupon information section 114 of the printer memory 120 to allow the printer to generate promotional coupons. Upon detection of dual systems of both gaming and promotional systems, the system detection section 115 of the printer memory 120 then may interact with the printer operation section 112, the voucher information section 113, and/or the coupon information section 114 of the printer memory 120 to allow the printer to function with a game or host to generate gaming vouchers and, if necessary or available, promotional coupons.

Generally, the contents of the printer operation section 112 are not frequently changed. The contents of the voucher information section 113 describe the format of the information that is printed on a gaming voucher. Contents of the voucher information section 113 are rarely changed. The coupon information section 114 may include the data that describes the format of the information that is printed on a promotional coupon. The contents of the coupon information section 114 are frequently changed. The contents of system detection section 115 are rarely changed.

The partitioning of the memory into separate code and data sections allows separate signatures to be maintained for each section. A signature, as an example the mathematical formula, may be generated for the memory content of a first section, such as the printer operation content 112, independently of all other memory sections. A second signature, again as an example of a mathematical formula, may be generated for a second memory section, such as the voucher data section 113, independently of all other memory sections. A third signature, again as an example of a mathematical formula, may be generated on a third memory section, such as the coupon section 114, independently of all other memory sections. The signatures provide an identifier that is statistically unique in describing the contents of each memory section. A fourth signature, again as an example of a mathematical formula, may be generated on a fourth memory section, such as the systems detection section 115, independently of all other memory sections. In addition, a signature may be generated for all the memory sections combined.

In practical use, the sectioned printer memory 120 allows the contents of the second section and/or third section to be viewed individually and separately from the contents of the first section. The mathematical formula used to generate the statistically unique identifier or signature of the printer is not changed, through alteration of the programming instruction codes or by another mechanism.

The second section and third section may contain the content of the printed image of a gaming voucher and a promotional coupon, respectively. For example, in the case of a promotional coupon, a gaming establishment operator may want to change the image and contents of the promotional coupon frequently. In this case, the gaming establishment may then change just the third section of memory including the coupon data without disturbing the first section of memory. The conditions that cause the gaming voucher and/or promotional coupon to be printed are controlled by the cashless enabled game or gaming table in accordance with the programming instruction codes and the coupon data.

The printer controller 130 also may include an Input/Output (I/O) device 118 coupled to the processor 116 by the system bus 122. The I/O device 118 may be used by the printer controller 130 to transmit control signals to the print module 100 and each paper tray 109. The I/O device 118 also may be used by the printer controller 130 to receive security feature and status signals from the print module 100 and each paper tray 109.

One or more communications devices 121 may be coupled to the system bus 122 for use by the printer controller 130 to communicate with a cashless gaming system host, game controller, or other host. The printer controller 130 may use the communication devices 121 to receive commands, program instructions, and other information from the external devices. In addition, the printer controller 130 may use the communication devices 121 to transmit printer status information to the external devices. Other communication devices also may be used by the printer controller 130 to couple in a secure fashion over a local area network 125, either a hard link or wireless 126 or both, for administrative or other purposes.

Additional communication devices and channels may be provided for communication with other peripheral devices as needed. For example, one communication device may be provided with a local communications port or interface, accessible from an exterior of a gaming machine hosting the printer that a technician may use to communicate with the printer controller 130 during servicing using an external controller 124. The external controller 124 may communicate with the printer controller 130 using Bluetooth, WiFi, infrared link, other short-range wireless communication link, or a hard link with an external connector in a secure manner.

In another example, one communication device may be a gating mechanism 127 which may be used to determine which controller is addressing the print module 100 as well as control the print module 100 shared resource. The gating mechanism 127, which may be internal or external to the printer, may be driven by firmware, software, electrical and/or mechanical mechanism.

The processor further may be coupled to an encryption/decryption module 119 that may be used to encrypt and decrypt messages encoded using an encryption standard. This enables the printer controller 130 to engage in secure transactions with external devices. The processor 116 may access the encryption/decryption module 119 either as a component through the bus 122 as shown or as an external device through a communications device using a high level communications protocol. In addition, the printer controller 130 also may include program instructions to perform encryption/decryption services as well.

The processor 116 further may be coupled to a display device 123 that may be used to display printer status information or media information. The processor 116 may access the display device 123 either as a component through the device 118 or as an external device through a communications device.

In operation, the processor 116 loads the programming instructions into the main memory 117 and executes the programming instructions to implement the features of the printer as described herein.

As illustrated, the printer controller 130 is shown as being electronically coupled to the print module 100 and one or more paper trays 109 without any mechanically coupling. The printer controller 130 may be mounted in a variety of ways and may be incorporated into various components of either the printer or the game hosting the printer. For example, the printer controller 130 may be attached to and supported by the print module 100, one or more paper trays 109, or the host game as may be required to mechanically integrate the printer into the host game.

The printer also may include procedures which may be used to monitor communications traffic on one or a plurality of ports or interfaces. Procedures also may be used to process a plurality of print jobs received at the print module 100 and/or other shared resources.

FIG. 1b is a block diagram of a distributed processing printer having two print controllers in accordance with an exemplary embodiment of the present invention.

As illustrated, the printer may include a print module 100 as described in detail above with regards to FIG. 1a and two print controllers, namely, print controller 1 (140) and print controller 2 (150). Print controller 1 (140) and print controller 2 (150) may be removably and electronically coupled to the print module 100. Print controller 1 (140) and print controller 2 (150) are constructed in a similar manner as print controller 130 of FIG. 1a.

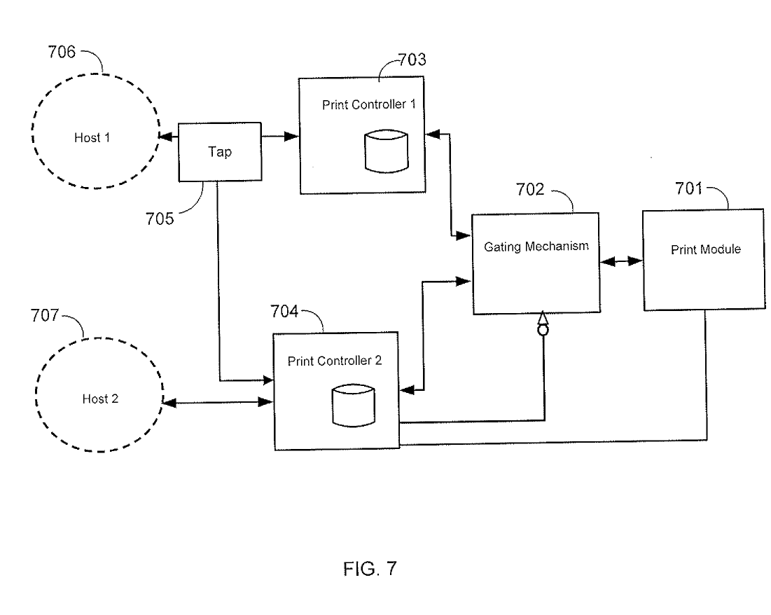

Similar to the print controller 130 of FIG. 1a, print controller 1 (140) may be coupled to an external controller 124, local area network 125, either a hard link or wireless 126 or both, and a gating mechanism 127. The print controller 1 (140) may also be coupled to a gaming host such as host 1 (141). Similar to print controller 1 (140), print controller 2 (150) may also be coupled to an external controller 152, local area network 153, either a hard link or wireless 154 or both, as well as being coupled to the gating mechanism 127 and a gaming host such as host 2 (151). The print controller 2 (150) may further be coupled to the host 1 (141) of print controller 1 (140) so that print controller 2 (150) may monitor communications from host 1 (141) to print controller 2 (140) as described in more detail below with regards to FIGS. 7 to 9.

Print controller 2 (150) may also be coupled to the gating mechanism 127, where the gating mechanism may control which of print controller 1 (140) and print controller 2 (150) may access the print module 100 as described in more detail below with regards to FIGS. 7 to 9.

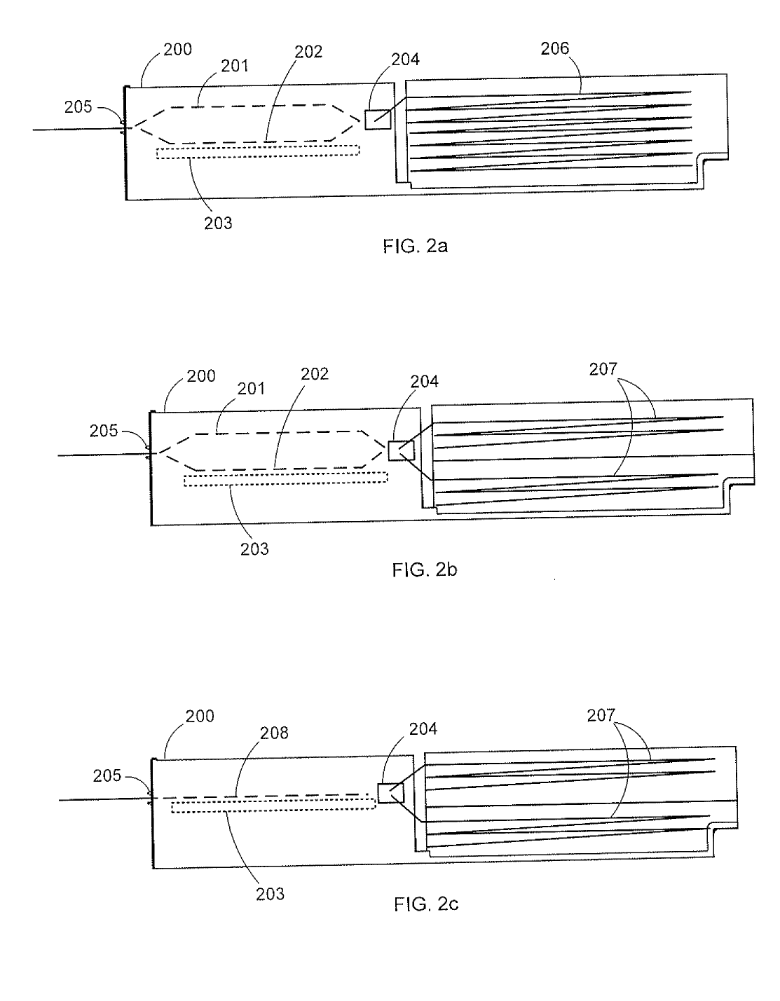

FIG. 2a is an illustration of a distributed processing printer with a media escrow area in accordance with an exemplary embodiment of the present invention.

As illustrated, the printer includes a print module 200 which may include a media escrow area 203 as previously described in FIG. 1a. The print module 200 also may include a plurality of paper paths such as paper path 1 (201) and paper path 2 (202), a print head 204, and a paper exit 205 as well as a paper routing mechanism, a paper retrieval mechanism and others not shown.

The printer also may include a paper tray 206 holding media which is used for printing gaming vouchers and promotional coupons. In operation, media is pulled from the paper tray 206 and routed through the print head 204 in the print module 200 for printing, then using a paper routing mechanism routed through either the first paper path 201 or the second paper path 202, depending on the type of print job, such as promotional coupon or gaming voucher. For example, a promotional coupon may be routed using paper path 2 (202) to be placed in a media escrow area 203 for holding. After the gaming voucher is generated or printed, the promotional coupon is pulled from the media escrow area 203 using a paper retrieval mechanism and dispensed from the printer through the paper exit 205.

Should a paper jam or any other error occur, or if the paper must be retracted into the printer, a paper retrieval mechanism may be used.

In one variation, the printer may generate and dispense one or a plurality of promotional coupons without a gaming voucher being generated or printed or receiving a cash-out signal.

FIG. 2b is an illustration of a distributed processing printer with a plurality of paper trays and a media escrow area in accordance with an exemplary embodiment of the present invention.

As illustrated, the printer includes a plurality of paper trays 207 horizontally stacked. Each tray may hold media such as later described or known in the art. The printer also may include a print module 200 which may include a media escrow area 203 as previously described in FIG. 1a. The print module 200 also may include a plurality of paper paths such as paper path 1 (201) and paper path 2 (202), a print head 204, and a paper exit 205 as well as a paper routing mechanism, a paper retrieval mechanism, among others previously described but not shown.

In operation, after receiving a cash-out signal, the printer may pull media from one of the paper trays 207, such as the bottom paper tray to generate a gaming voucher. The voucher is printed and pulled through a paper routing mechanism, where the routing mechanism may be used to pull the gaming voucher using paper path 1 (201), after which the gaming voucher is dispensed from the printer using the paper exit 205.

Additionally, a signal may be sent to the printer to generate one or a plurality of promotional coupons. The one or plurality of promotional coupons may be printed after receiving a cash-in signal from the game, in mid-session of play of the game, or after receiving a cash-out signal from the game. After receiving a signal to print one or a plurality of promotional coupons, the printer may pull media from one of the paper trays 207, such as the top paper tray to generate each coupon. Each coupon is printed and pulled through a paper routing mechanism, where the routing mechanism may be used to pull each coupon to a media escrow area 203 using paper path 2 (202), where each coupon may be stored pending the receipt of a cash-out signal, after which each coupon is dispensed with a gaming voucher, if any, using the paper exit 205.

In another embodiment, the printer may include one paper tray where media is pulled and printed.

Should a paper jam or any other error occur, or if the paper must be retracted into the printer, a paper retrieval mechanism may be used.

FIG. 2c is an illustration of a distributed processing printer with a plurality of paper trays utilizing one paper path 208 in accordance with an exemplary embodiment of the present invention.

As illustrated, the printer may include any or all components as previously described in FIG. 2b. Additionally, the operations may be similar to that described in FIG. 2a and FIG. 2b.

In operation, after receiving a cash-out signal, the printer may pull media from one of the paper trays 207, such as the top paper tray to generate a gaming voucher. The voucher is printed and pulled through a paper routing mechanism, where the routing mechanism may be used to pull the gaming voucher through the paper path 208, after which the gaming voucher is dispensed from the printer using the paper exit 205.

Additionally, a signal may be sent to the printer to generate one or a plurality of promotional coupons. The one or plurality of promotional coupons may be printed after receiving a cash-in signal from the game, in mid-session of play of the game, or after receiving a cash-out signal from the game. After receiving a signal to print one or a plurality of promotional coupons, the printer may pull media from one of the paper trays 207 to generate each coupon. Each coupon is printed and pulled through a paper routing mechanism, where the routing mechanism may be used to pull each coupon to a media escrow area 203, where each coupon may be stored pending the receipt of a cash-out signal, after which each coupon is dispensed with a gaming voucher, if any using the paper exit 205.

In another embodiment, the printer may include one paper tray and one paper path.

In a variation, one tray may be used to hold scrap media. In this embodiment, should a paper jam or any other error occur, or if the paper must be retracted into the printer, the paper routing mechanism may be used as a paper retrieval mechanism to pull the media into the scrap paper tray.

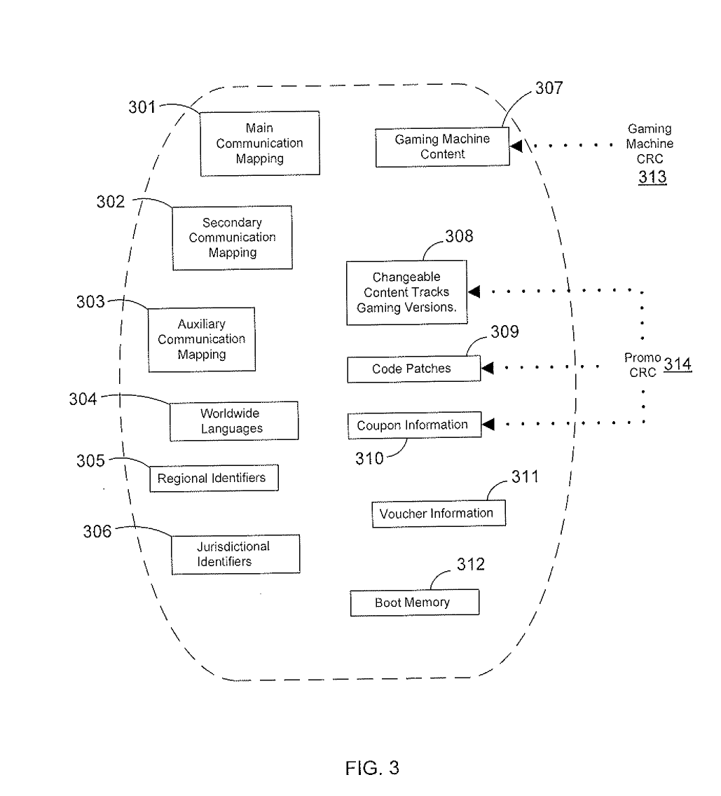

FIG. 3 is an illustration of the segmented memory and memory map of the distributed processing printer in accordance with an exemplary embodiment of the present invention.

The segmented memory may include all previously disclosed in FIG. 1a. Additionally, the memory may include areas for main communication mapping 301, secondary communication mapping 302, auxiliary communication mapping 303, worldwide languages 304, regional identifiers 305, jurisdictional identifiers 306, gaming machine content 307, changeable content tracks gaming versions 308, code patches 309, coupon information 310, voucher information 311, and boot memory 312, among others not shown. The memory also may be separate from other memory where one portion of memory may exist in the distributed processing printer and another portion of memory may exist in one or a plurality of controllers.

The main communication mapping area 301 of the printer memory may be used for mapping to a gaming machine. Contents for mapping may include among others the currently active gaming machine interface, mapping to ticket files, mapping to coupon files, and gaming machine implementation information. Additionally, the main communication mapping area 301 of the printer memory may be used for downloading capabilities for gaming machine application code, gaming machine application code patches, and gaming machine templates, among others.

The secondary communication mapping area 302 of the printer memory may be used for mapping to a host system, a plurality of host systems, and or a gaming machine. Contents for mapping may include among others the currently active host system, plurality of host systems, or gaming machine interface, mapping to ticket files, mapping to coupon files, and host system or systems implementation information. Additionally, the secondary communication mapping area 302 of the printer memory may be used for downloading capabilities for application code from a host system, a plurality of host systems, or a gaming machine, application code patches from a host system, a plurality of host systems, or a gaming machine, among others.

The auxiliary communication mapping area 303 of the printer memory may be used for mapping to an external device. Contents for mapping may include printer maintenance functions as well as downloading capabilities for gaming machine application code, gaming machine application code patches, and gaming machine templates, among others.

Additionally, any one, all, or combination of any communication mapping area may be used for download capabilities for promotional codes, promotional templates, promotional code patches, configuration to one or multiple worldwide languages, regions, or jurisdictions, configuration to one or multiple protocols, configuration to prior firmware versions, and printer maintenance functions as well as procedures which allow for print arbitration awareness and additional communication interface awareness.

In one variation, the content of the content of any communication mapping area may be alternated with another communication mapping area.

The worldwide languages area 304 of the printer memory may be used to support configuration to languages used worldwide, such as Korean, German, and Japanese as well as the ability to detect which language is in use and identify the worldwide language using a unique identifier.

The regional identifiers area 305 of the printer memory may be used to support worldwide regional requirements by gaming regulators and other regulating agencies, such as a unique identifier for each region.

The jurisdictional identifiers area 306 of the printer memory may be used to support worldwide jurisdictional requirements by gaming regulators and other regulating agencies, such as a unique identifier for each jurisdiction.

The gaming machine content area 307 of the printer memory may be used for information related to the gaming machine such as gaming machine implementation information and a table identifying each gaming machine application code patch. Additional information in this area of the printer memory may include mapping to specific gaming machine regions, gaming machine templates, a specific ticket file, and a specific coupon file. This area may be used to create a gaming machine CRC signature 313.

The changeable content tracks gaming versions area 308 of the printer memory may be used for information related to content which may be modified in gaming machines versions such as all print regions, all ticket files, all coupon files, and any tables containing conversion data for worldwide configuration.

The code patches area 309 of the printer memory may be used to create a link between gaming machine code patch table from the gaming machine content area 307 and the promotional code patch table 314 from the coupon information area 310.

The coupon information area 310 of the printer memory may be used for information related to promotions such as promotion implementation information, a table identifying each promotion code patch, and instructions and data as previously disclosed in FIG. 1a.

The voucher information area 311 of the printer memory may be used for information related to gaming vouchers such as instructions and data as previously disclosed in FIG. 1a.

The changeable contents tracks gaming versions 308, code patches 309, and coupon information areas 310 of the printer memory may be used to create a promotional CRC signature 314.

The boot memory 312 may be used for procedures and other information related to the printer during power up or when the power is recycled, among others.

In one embodiment, the fields of a gaming voucher or promotional coupon may be described using description data included in an electronic template that may be stored by a printer in the printer memory such as in the gaming machine content area 307, the coupon information area 310, or the voucher information area 311. These fields may include a barcode field, text field, a graphic field, and line/box draw field. A template may include a plurality of these fields in combination, resulting in a paste-up style printed gaming voucher or promotional coupon. A plurality of templates describing different types of gaming vouchers may be stored in the voucher information section of the printer memory to be used by the printer to support the gaming operations of a gaming establishment. Similarly, a plurality of templates describing different types of promotional coupons may be stored in the coupon information section 310 of the printer memory to be used by the printer to support the promotional operations of a gaming establishment.

The actual value or data for each of the fields described in a template may or may not be included in the template itself. Instead, the template may include instructions on how to generate a gaming voucher or promotional coupon but may not include the actual data printed onto the gaming voucher or promotional coupon. For example, a template may include a barcode field for printing a barcode. However, the actual value of the barcode is transmitted to a printer from a host system at the time a gaming voucher or promotional coupon is generated using the template. In this way, a gaming voucher or promotional coupon may have fields that include static data, such as a logo in a graphic field, or dynamic data, such as the name of a patron in a text field. In this way, customized gaming vouchers or promotional coupons may be printed by a printer without transferring large amounts of data through a communications device.

As an example, the host system may transmit gaming voucher data or promotional coupon data to the printer to generate a gaming voucher or promotional coupon, respectively. To further describe, the host system also may include a reference to a template definition so that the dynamic data transmitted by the host system can be combined with the static data stored in the printer to generate a complete gaming voucher or promotional coupon depending on the host system. Additionally, since it is possible to store all the fields used on a gaming voucher or promotional coupon with the printer memory, a host system may issue a complete gaming voucher or promotional coupon by simply sending a reference to a gaming voucher or promotional coupon stored in the printer memory to generate the gaming voucher or promotional coupon in its entirety.

In another embodiment, the fields of a gaming voucher or promotional coupon and instructions on how to generate a gaming voucher or promotional coupon may be used without an electronic template for the generation of a gaming voucher or promotional coupon. The fields may include any or all those previously described.

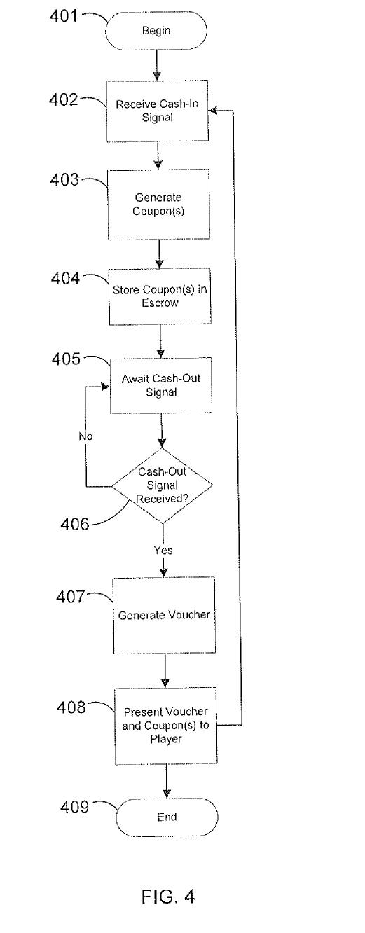

FIG. 4 is a block diagram of the media escrow process for one or a plurality of promotional coupons in accordance with an exemplary embodiment of the present invention.

As illustrated, the process begins (401) with a cash-in signal being received (402). The cash-in signal may be transmitted by a host system such as a game to the printer. At any time after the printer receives the signal, the printer may generate one or a plurality of promotional coupons (403), after which each printed coupon is stored (404) in the media escrow area 105 previously described in FIG. 1a. The process continues with the printer awaiting a cash-out signal (405), which may be transmitted by a host system such as a game to the printer.

If the printer receives a cash-out signal (406), the printer may generate a gaming voucher (407) after which the voucher and each promotional coupon stored in the media escrow area 105 are presented (408) to the player. Thereafter, the process may end (409) or loop back to receive cash-in signal (402) for the real-time monitoring of signals such as a cash-in signal.

In one embodiment, a distributed processing printer may process data related to one or a plurality of promotional coupons and print such coupons at the beginning of a player session such as after the game coupled to the printer transmits to the printer that a cash-in signal was received. Each promotional coupon is stored in the media escrow area 105 until the game transmits to the printer that a cash-out signal was received, after which the printer may print a gaming voucher and present to a player the gaming voucher and the one or plurality of promotional coupons from the media escrow area 105.

In another embodiment, the printer may process and print one or a plurality of promotional coupons anytime during a player session and store each coupon in the media escrow area 105. Again, after the coupled game transmits to the printer that a cash-out signal was received, the printer may print a gaming voucher and present to a player the gaming voucher and each coupon stored in the media escrow area 105.

In a preferred embodiment, the printing and storing of media in a media escrow area may occur simultaneously with other functions or processes of the printer such as interfacing and communicating with other devices.

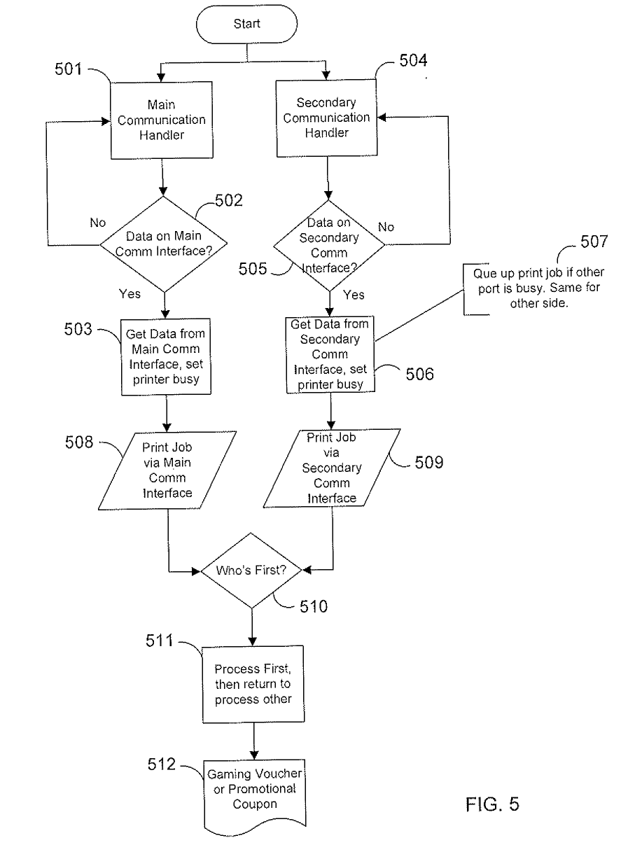

FIG. 5 is an illustration of print arbitration process of the distributed processing printer in accordance with an exemplary embodiment of the present invention.

As illustrated, the process for the main communication interface begins with the Main Communication Handler 501. A determination is made (502) whether data exists on the main communication interface. If data 508, such as a gaming voucher, exists on the main communication interface, the system gets (503) the data 508 from the main communication interface and sets the printer to busy. If data 508 does not exist on the main communication interface, the process returns to the Main Communication Handler 501.

The process for the secondary communication interface begins with the Secondary Communication Handler 504. A determination is made (505) whether data exists on the secondary communication interface. If data 509, such as a promotional coupon, exists on the secondary communication interface, the system gets (506) the data from the secondary communication interface and sets the printer to busy. If data 509 does not exist on the secondary communication interface, the process returns to the Secondary Communication Handler 504.

If the printer is busy using any communication interface, the data from the other communication interface is queued (507).

The process continues with the system identifying (510) which data was received first. Because the process begins with Main Communication Handler 501 determining whether data 508 exists on the main communication interface, if data 508 exists on the main communication interface the data 508 will be identified at 510 as being received first. After identifying the data received first, the system processes (511) the first data to generate for instance (512) a gaming voucher or promotional coupon, then returns to process the second data to generate for instance a gaming voucher or promotional coupon.

An example of one arbitration scheme would be the printer giving priority to a gaming voucher print job which comes from the gaming machine (on the main communication interface), and then queuing a coupon print job (on the secondary communication interface) behind the gaming voucher. Another example of an arbitration scheme would be the printer receiving a coupon print job on its secondary communication interface, then holding the coupon for a period of time awaiting arrival of a gaming voucher on the main communication interface. If the gaming voucher did not arrive within a reasonable amount of time, the coupon could either be printed or canceled by the printer. In addition to coupon print data, the printer would receive certain static promotional campaign data on its secondary communication interface. The static data could include graphic icons which are necessary to print on the various coupons, portions of the coupons which would never change with an award, and optionally, a set of trigger conditions which would cause the printer to trigger a coupon.

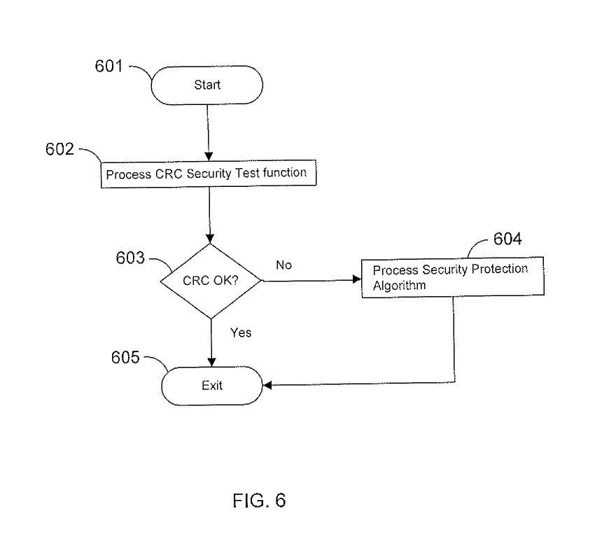

FIG. 6 is a diagram of a security test performed on the memory of the distributed processing printer in accordance with an exemplary embodiment of the present invention.

As illustrated, the process begins (601) with the processing of the CRC security test (602). If the CRC is verified (603) and the contents or code has not changed, the process ends (605). Otherwise, the security protection procedure is processed (604).

An example security protection procedure may perform all of the following checks to determine the validity of memory contents of the printer: a security check on the gaming machine CRC 313, promotional CRC 314, boot memory 312, and any code patches 309. If at any time, a function of the procedure fails, an error report may be returned to a host system and printer functions may be halted.

FIG. 7 is a diagram of a distributed processing printer comprising a plurality of controllers in accordance with an exemplary embodiment of the present invention.

As illustrated, the distributed processing printer may include a plurality of controllers such as print controller 1 (703) and print controller 2 (704), a gating mechanism 702, and a print module 701, among others previously disclosed but not shown.

Print controller 1 (703) and print controller 2 (704) may be coupled to the print module 701 of the distributed processing printer through a gating mechanism 702. Additionally, print controller 2 (704) also may be coupled to the print module 701, for example, to monitor the print module activity and determine the progress of print activity of another controller as well as coupled to the gating mechanism 702 to select the control line of each controller.

The printer may include shared resources such as the print module 701 and a gating mechanism 702, among others. The print module 701 may be utilized to produce human and/or machine readable indicia on media based on signaling from a host. The gating mechanism 702 may be used to determine which controller is addressing the print module 701 as well as control the print module 701 shared resource. The gating mechanism 702, which may be internal or external to the printer, may be driven by firmware, software, electrical and/or mechanical mechanism.

The data received from a host may include any data previously disclosed. The data also may include play activity data, which may be received in real time. For example, a plurality of ports or interfaces and a plurality of controllers where one port may be coupled to an electronic gaming machine which outputs real time play activity data of the game. One controller may receive the data and look for play activity which may trigger printing of a promotional coupon or message. When such a trigger match is seen, the controller may print the particular promotional coupon or message and signal its coupled host on another port or interface as to the creation of the promotional coupon or message.

In one embodiment, procedures and code monitors communications traffic on one port or interface coupled to one controller and determine if the controller has been signaled by its coupled host to create printed output, and when so determined, gating the print module 701 and any other switch-able shared resources of that controller.

In another embodiment, procedures and code provides for a second controller to receive signaling from its coupled host, queue up printed output, monitor communications between a first controller and its coupled host, monitor print activity of the first controller, determine when the first controller has finished with the shared resources, and when so determined, gate control of the shared resources to itself and print its queued up output.

In another embodiment, procedures and code provides for a second controller, such as print controller 2 (704), to receive signaling from its coupled host, monitor signaling between a first controller, such as print controller 1 (703), and its coupled host, determine if print activity is required by the first controller and if none is required, take ownership of the shared resources and cause the print module 701 to create printed output, further cause the print module 701 to deposit the printed output into a physical escrow area, all while continuing to monitor communications between the first controller and its coupled host, determining when its print activity must cease in order to grant ownership of the shared resources to the first controller, then gating the print module 701 and shared resources to the first controller all in a manner transparent to the first controller so that the first controller may produce printed output.

These shared resources may be utilized by a plurality of coupled controllers and components thereof. For example, one controller such as print controller 1 (703) may be coupled to a game such as host 1 (706) using a port or interface. The same controller may be coupled to the gating mechanism 702 to the print module 701. The data received from host 1 (706) may be received on print controller 1 (703) to determine if and when that controller will signal the shared resource of the print module 701 to produce human and/or machine readable indicia on the media of the printer, such as a gaining voucher.

Each controller processes communications, image generation, and print data storage. Each controller may send and receive signaling from a separate and coupled host. Each controller may be internal or external to the distributed processing printer where the printer and each controller transmits signaling over a physical distance.

Each controller may include a processor as previously disclosed. Each controller and coupled processor may send and receive signaling to and from another controller or controllers. Each controller and coupled processor may include a mechanism to determine whether it or another controller was connected to the shared resource print module 701 at any given time. Additionally, the processor may include a plurality of memory where the processor may perform task switching between the execution of code from a first memory and a second memory. The task switching may be performed in response to host communications from one or a plurality of hosts. The code executed and the print data accessed in each memory may provide a unique environment from the perspective of each connected host. The task switching may be performed so as to produce pseudo-simultaneous operation of the executable code in each memory in a manner transparent to the host coupled to a port or interface of the printer.

Additionally, each controller and coupled processor may operate independently from the other.

In one embodiment, print controller 1 (703) and coupled processor may monitor the communications of print controller 2 (704) and/or between print controller 2 (704) and its coupled host.

Also illustrated is a plurality of hosts, each coupled to a print controller using a port or interface. For example, host 1 (706) may coupled to print controller 1 (703) and host 2 (707) may be coupled to print controller 2 (704).

In one embodiment, print controller 1 (703) may be coupled to a game and running legacy firmware for the purposes of printing gaming vouchers. Print controller 2 (704) may be coupled to a promotional host for the purposes of printing promotional coupons and other promotional materials in a manner in a manner that is completely transparent to the legacy firmware running on print controller 1 (703).

Also illustrated is a communications tap 705 which provides for a controller, such as print controller 2 (704) to monitor the communications between another controller, such as print controller 1 (703) and its coupled host.

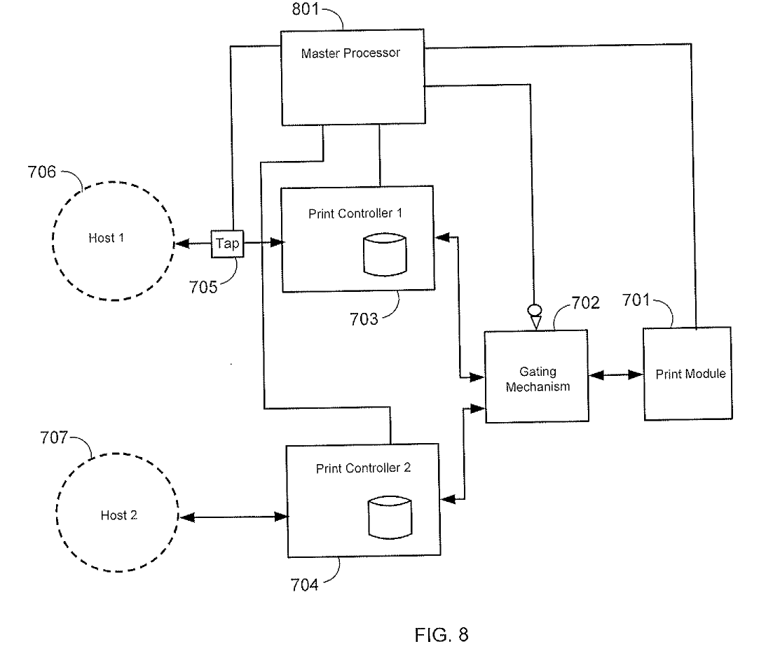

FIG. 8 is a diagram of a distributed processing printer with a processor monitoring communications of a plurality of controllers in accordance with an exemplary embodiment of the present invention.

As illustrated, the distributed processing printer may include any or all those previously disclosed in FIG. 7 and others previously disclosed but not shown. Additionally, the printer may include a master processor 801 which processes communications, image generation, and print data storage, among others.

In this embodiment, the master processor 801 may be coupled to the print module 701 to, among others, monitor the print module activity and determine the progress of print activity of the other controllers such as print controller 1 (703) and print controller 2 (704) as well as coupled to the gating mechanism 702 to select the control line of each controller.

The master processor 801 also may be coupled to print controller 1 (703) and print controller 2 (704). The master processor 801 may monitor the communications of each controller and thereby determine which controller is connected to operate the shared resources of the printer. The master processor 801 may signal one or a plurality of controllers as to which controller has been granted ownership of the shared resources of the printer.

The master processor 801 also may be internal or external to the printer, the printer and the master processor being able to transmit signaling over a physical distance.

As with the other controllers, the master processor 801 also may determine whether it or another controller was connected to the shared resource print module 701 at any given time. The master processor 801 also may perform task switching between the execution of code from a first memory and a second memory where the task switching may be performed in response to host communications from one or a plurality of hosts. The code executed and the print data accessed in each memory may provide a unique environment from the perspective of each connected host. The task switching may be performed so as to produce pseudo-simultaneous operation of the executable code in each memory in a manner transparent to the host coupled to a port or interface of the printer. The master processor 801 also may monitor the communications of one or a plurality of controllers and/or between another controller and its coupled host and may send and receive signaling to and from one or a plurality of controllers.

The master processor 801 also may be coupled to a communications tap 705 for the purposes of monitoring communications between another controller and its coupled host.

In the operation of one embodiment, one controller such as print controller 1 (703) may be coupled to a game such as host 1 (706) using a port or interface. The same controller may be coupled to the gating mechanism 702 to the print module 701. The data received from game may be received on print controller 1 (703) to determine if and when print controller 1 (703) will signal the shared resource of the print module 701 to produce human and/or machine readable indicia on the media of the printer, such as a gaining voucher.

Print controller 2 (704) may be coupled to a promotional host such as host 2 (707) using a port or interface. The same controller may be coupled to the gating mechanism 702 to the print module 701. The data received from the promotional host may be received on print controller 2 (704) to determine if and when print controller 2 (704) will signal the shared resource of the print module 701 to produce human and/or machine readable indicia on the media of the printer, such as a promotional coupon or promotional message.

The master processor 801 may determine that the print module 701 is connected to print controller 1 (703) to produce a gaming voucher. In this case, the master processor 801 may signal print controller 2 (704) to queue its print job of a promotional coupon until such time that print controller 2 (704) receives signaling from the master processor 801 that it is connected to the print module 701. The master processor 801 using the gating mechanism 702 then may allow print controller 2 (704) to produce a promotional coupon using the print module 701.

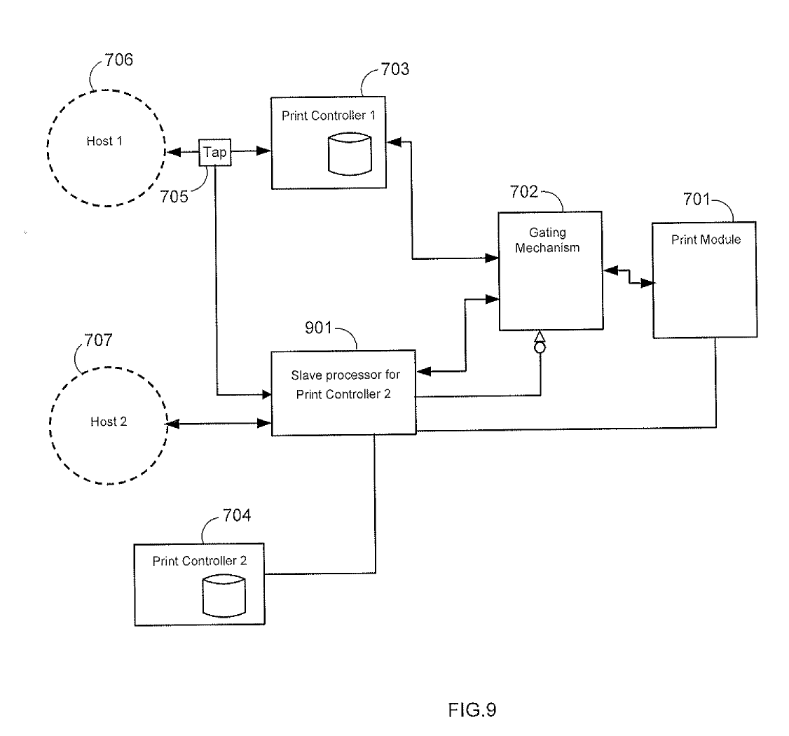

FIG. 9 is a diagram of a distributed processing printer with a processor serving as a slave to a secondary controller in accordance with an exemplary embodiment of the present invention.

As illustrated, the distributed processing printer may include any or all those previously disclosed in FIG. 7 and others previously disclosed but not shown. Additionally, the printer may include a slave processor 901 which may serve as a slave to implement the control commands from a coupled controller into electronic control signals.

The slave processor 901 may be coupled to a controller, such as print controller 2 (704) where the slave processor 901 may serve as a slave to remotely locate a controller, such that the controller may transmit messages to the slave processor 901 ordering it to perform the process or processes necessary to operate the shared resources.

The slave processor 901 also may be coupled to the print module 701 to, among others, monitor print module activity 701 and determine the progress of print activity of the other controllers as well as coupled to the gating mechanism 702 to select the control line of each controller.

The slave processor 901 also may be internal or external to the printer, the printer and the slave processor being able to transmit signaling over a physical distance.

As with the other controllers, the slave processor 901 also may determine whether it or another controller was connected to the shared resource print module 701 at any given time. The slave processor 901 also may perform task switching between the execution of code from a first memory and a second memory where the task switching may be performed in response to host communications from one or a plurality of hosts. The code executed and the print data accessed in each memory may provide a unique environment from the perspective of each connected host. The task switching may be performed so as to produce pseudo-simultaneous operation of the executable code in each memory in a manner transparent to the host coupled to a port or interface of the printer. The slave processor 901 also may monitor the communications of one or a plurality of controllers and/or between another controller and its coupled host and may send and receive signaling to and from one or a plurality of controllers.

The slave processor 901 may be coupled to a host such as host 2 (707) through a port or interface. The slave processor 901 also may be coupled to a communications tap 705 for the purposes of monitoring communications between another controller and its coupled host.

In this embodiment, the data received from host 2 (707) such as a promotional host may be received on the slave processor to determine if and when print controller 2 (704) will signal the shared resource of the print module 701 to produce human and/or machine readable indicia on the media of the printer, such as a promotional coupon.

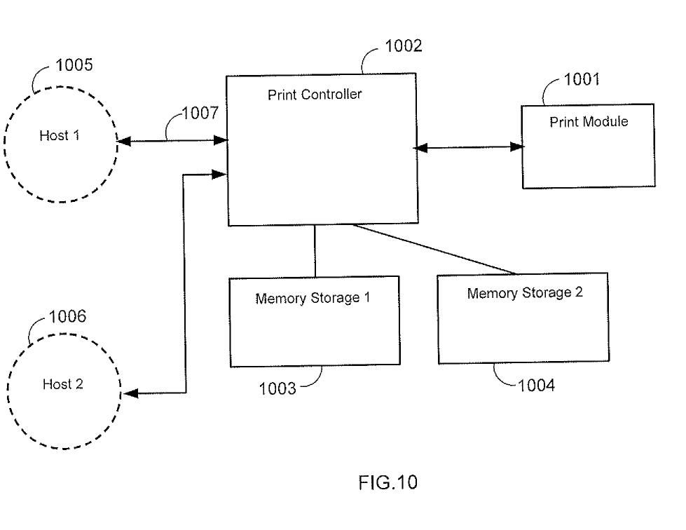

FIG. 10 is a diagram of a distributed processing printer comprising one controller in accordance with an exemplary embodiment of the present invention.

As illustrated, the distributed processing printer may include any or all those previously disclosed in FIG. 7 and others previously disclosed but not shown. In this embodiment, the printer may include one print controller 1002 coupled to a plurality of host systems, each connection through a port or interface.

The print controller 1002 may include a plurality of memory where each memory may provide firmware, code and data storage/processing which is unique to each separate and coupled host such as host 1 (1005) and host 2 (1006). For example, the plurality of memory may include a memory storage 1 (1003) and a memory storage 2 (1004) as illustrated in FIG. 10. Also, the plurality of memory may be separate and/or segmented from other memory where one portion or portions of memory may exist in the printer and another portion or portions of memory may exist in the controller. The print controller 1002 of FIG. 10 may include any or all the functionality previously disclosed. Additionally, the print controller 1002 may be internal or external to the printer, the printer and the print controller 1002 being able to transmit signaling over a physical distance.

The print controller also may be coupled to a communications tap 1007 for the purposes of monitoring communications between its coupled host or hosts.

In the operation of one embodiment, the print controller 1002 may be coupled to host 1 (1005) such as a game using a port or interface and to host 2 (1006) such as a promotional host using another port or interface. The print controller 1002 also may be coupled to the print module 1001. The data received from the game may be received by the print controller 1002 to determine if and when the controller 1002 will signal the print module 1001 to produce human and/or machine readable indicia on the media of the printer, such as a gaming voucher. Likewise, the data received from the promotional host may be received by the print controller 1002 to determine if and when the controller 1002 will signal the print module 1001 to produce a promotional coupon or other promotional material.

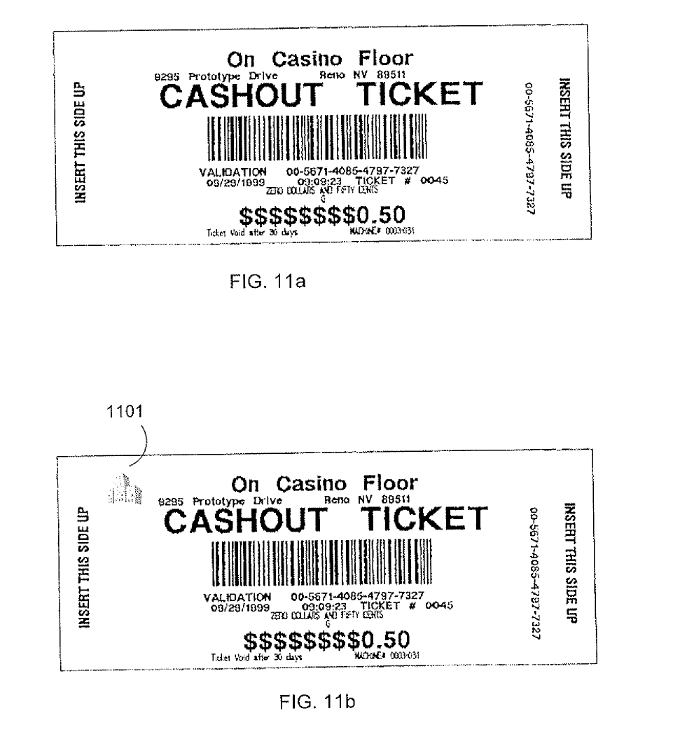

FIG. 11a is a prior art illustration of a gaming voucher used currently used in a gaming environment in accordance with an exemplary embodiment of the present invention.

The voucher shown is produced from commands issued by the cashless enabled game to a printer in response to a player's request to cash out. The voucher includes features such as a validation number, printed in both a human readable form such as a character string and in a machine-readable form such as a bar code, time and date stamps, cash-out amount, casino location information, cashless enabled game identifier, and an indication of an expiration date.

FIG. 11b is an illustration of a grayscale gaming voucher for use in a gaming environment in accordance with an exemplary embodiment of the present invention.

This figure includes the same features as the voucher described in FIG. 11a. However, FIG. 11b includes a grayscale logo 1101 which is generated using the grayscale printing capabilities of the printer. Additionally, if the media used with the gaming voucher is color media, the grayscale logo may be set to print in multiples shades of the color set in the media.

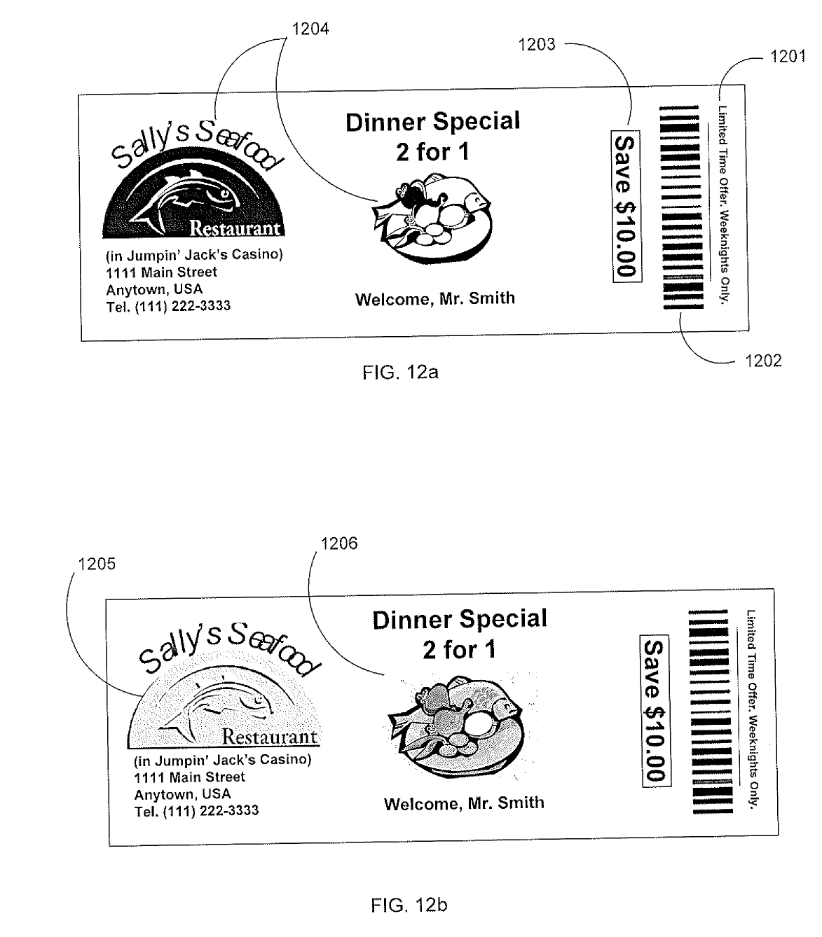

FIG. 12a is a prior art illustration of a promotional coupon in accordance with an exemplary embodiment of the present invention.

In this example, a promotional coupon may include four types of data fields: text fields, such as text field 1201; barcode fields, such as barcode field 1202; graphic fields, such as graphic fields 1204; and line/box draw fields, such as line/box draw field 1203.

In this prior art illustration, the graphic fields are one color images such as a black and white images.

FIG. 12b is an illustration of a grayscale promotional coupon in accordance with an exemplary embodiment of the present invention.

This figure includes the same features as the promotional coupon described in FIG. 12a. However, FIG. 12b uses as the graphic field a grayscale logo 1205 and grayscale graphic 1206 which may be generated using the grayscale printing capabilities of the printer. Similar to a gaming voucher, if the media used with a promotional coupon is color media, the grayscale logo 1205 and grayscale graphic 1206 may be set to print in multiples shades of the color set in the media.

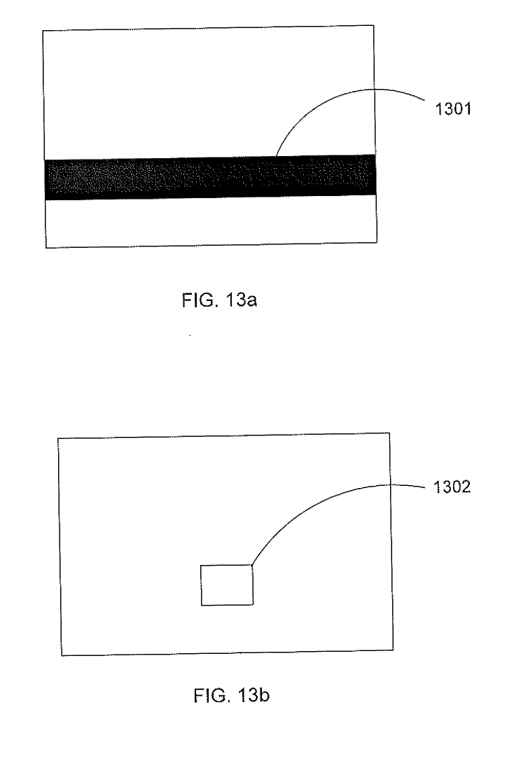

FIG. 13a is an illustration of a rewritable card in accordance with an exemplary embodiment of the present invention. The rewritable card shown is produced from commands issued by the cashless enabled game to the printer in response to a player's request to cash out. The card may include features such as a validation number, printed in both a human readable form such as a character string and in a machine-readable form such as a bar code, time and date stamps, cash-out amount, casino location information, cashless enabled game identifier, and an indication of an expiration date. Included may be a security feature that may take one or more forms.

The printer may interface with various types of media for the convenience of player identification, statistical information, playing credits, banking information, and other information of interest to the player. For example, the printer may interface with the rewritable card, thermal reversible media, RF Fiber Media, the RF Fiber Media consists of radio frequency resonators, or fibers, that are randomly or pseudo-randomly placed on a carrying medium, the medium can be standard thermal paper or other suitable carrying medium, the collection of the resonators placed on the medium in the random manner form a relatively unique signature, the signature can be obtained by applying a electro magnetic signal, the signal typically in the radio frequency spectrum, as the signal is applied, each of the resonators produce a electro magnetic response to the signal, the response is received and the collection of all the responses form the signature, the signature either alone or in combination with other authentication mechanisms of gaming voucher and/or promotional coupon provide a increased certainty of the authentication. The printer may interface with RF ID Tag Media, the RF ID Tag Media contains the mechanisms to allow information to be written and read electronically, the information is used either alone or in combination with other authentication mechanisms of the gaming voucher and/or promotional coupon provide an increased certainty of the authentication.

In one media in accordance with an exemplary embodiment of the present invention, one face of the media includes a layer of writable and erasable thermally sensitive film. The thermal film becomes opaque at one temperature level but becomes transparent at another temperature. This effect can be used to create a thermally rewritable card that may be used as, for example, a gaming voucher or promotional coupon.

The card also may include a read/write magnetic strip 1301 for encoding of any of the information described above.

In addition, the magnetic strip 1301 may be used to transmit information to the distributed processing printer. For example, the magnetic strip 1301 may encode instructions such as configuration flags or programming instructions used to reconfigure or reprogram the distributed processing printer.

FIG. 13b is an illustration of another portion of a rewritable card having a static memory 1302 in accordance with an exemplary embodiment of the present invention. The card also may include a static memory 1302 embedded in the card so that the card may be used as a “smart” card for encoding of any of the information described above.

In addition, the static memory 1302 may be used to transmit information to the distributed processing printer. For example, the static memory 1302 may encode instructions such as configuration flags or programming instructions used to reconfigure or reprogram the distributed processing printer.

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A distributed processing printer comprising:
a print module;
a gating mechanism coupled to the print module;
a first print controller coupled to the gating mechanism, the first print controller configured to print received data using the print module;
a second print controller coupled to the gating mechanism and the print module, the second print controller configured to print received data using the print module,
wherein the gating mechanism is configured to control the print module on the basis of a determination of which of the first print controller or the second print controller is addressing the print module.

2. The distributed processing printer of claim 1, wherein the second print controller is configured to monitor print activity of the first print controller through the print module.

3. The distributed processing printer of claim 1, wherein the second print controller is configured to monitor communications between the first controller and a host coupled to the first controller.

4. The distributed processing printer of claim 1, further comprising:
a master processor,
wherein the master processor is coupled to the print module, the gating mechanism, the first print controller, and the second print controller,
wherein the master processor monitors print activity of the first print controller and the second print controller, and
wherein the master processor determines which of the first print controller and the second print controller may access the print module using the gating mechanism.

5. The distributed processing printer of claim 1, wherein the second print controller includes:
a slave processor coupled to the gating mechanism and the print module; and
an external print controller coupled to the slave processor,
wherein the slave processor is configured to receive messages from the external print controller and to perform functions of the second print controller in response to the received messages.

6. The distributed processing printer of claim 1, wherein whether the first print controller or the second print controller has access to the print module depends on which of the controllers receives data first.

7. The distributed processing printer of claim 6, wherein if the first print controller receives data for printing a voucher first, the first print controller is given priority to process the received data first.

8. The distributed processing printer of claim 6, wherein if the second controller receives data for printing a promotional coupon first, the promotional coupon data is held until the second print controller receives corresponding voucher print data, and the promotional coupon data is processed for printing after the voucher data is processed for printing.

9. The distributed processing printer of claim 1, wherein after receiving a cash-in signal, the second print controller prints a promotional coupon using the print module, and the promotional coupon is stored in an escrow area, and wherein after receiving a cash-out signal, the first print controller prints a voucher using the print module, and the voucher and the coupon stored in the escrow area are presented to a user.

10. A distributed processing printer comprising:
a print module;
a gating mechanism coupled to the print module;
a first computer-readable memory storage storing first computer-executable code for printing received data using the print module;
a second computer-readable memory storage storing second computer-executable code for printing received data using the print module; and
a processor coupled to the print module and the gating mechanism, the processor performing task switching between execution of the first computer-executable code and the second computer-executable code,
wherein the gating mechanism is configured to control the print module on the basis of a determination of which of the first computer-executable code or the second computer-executable code is being used for printing received data using the print module.
The distributed processing printer of claim 1, wherein the first print controller is, and wherein.

11. A method of operating a distributed processing printer, comprising:
printing received data with a first print controller using a print module, the first print controller being coupled to a gating mechanism, and the gating mechanism being coupled to the print module;
printing received data with a second print controller using the print module, the second print controller being coupled to the gating mechanism and the print module;
wherein the gating mechanism is configured to control the print module on the basis of a determination of which of the first print controller or the second print controller is addressing the print module.

12. The method according to claim 11, wherein the second print controller is configured to monitor print activity of the first print controller through the print module.

13. The method according to claim 11, wherein the second print controller is configured to monitor communications between the first controller and a host coupled to the first controller.

14. The method according to claim 11, further comprising:
monitoring print activity of the first print controller and the second print controller using a master processor, the master processor being coupled to the print module, the gating mechanism, the first print controller, and the second print controller,
wherein the master processor determines which of the first print controller and the second print controller may access the print module using the gating mechanism.

15. The method according to claim 11, wherein the second print controller includes:
a slave processor coupled to the gating mechanism and the print module; and
an external print controller coupled to the slave processor,
wherein the slave processor is configured to receive messages from the external print controller and to perform functions of the second print controller in response to the received messages.

16. The method according to claim 11, wherein whether the first print controller or the second print controller has access to the print module depends on which of the controllers receives data first.

17. The method according to claim 16, wherein if the first print controller receives data for printing a voucher first, the first print controller is given priority to process the received data first.

18. The method according to claim 16, wherein if the second controller receives data for printing a promotional coupon first, the promotional coupon data is held until the second print controller receives corresponding voucher print data, and the promotional coupon data is processed for printing after the voucher data is processed for printing.

19. The method according to claim 11, wherein after receiving a cash-in signal, the second print controller prints a promotional coupon using the print module, and the promotional coupon is stored in an escrow area, and wherein after receiving a cash-out signal, the first print controller prints a voucher using the print module, and the voucher and the coupon stored in the escrow area are presented to a user.
